(19) United States
(12) Patent Application Publication
(10) Pub. No.: US 2026/0221408 A1
(43) Pub. Date: Jul. 30, 2026

(54) MASS SPECTROMETER AND METHOD FOR DISASSEMBLING MASS SPECTROMETER

(71) Applicant: Hitachi High-Tech Corporation, Tokyo (JP)

(72) Inventors: Hiroyuki YASUDA, Tokyo (JP); Koji ISHIGURO, Tokyo (JP); Akimasa OSAKA, Tokyo (JP); Isao FURUYA, Tokyo (JP); Suguru KONDO, Tokyo (JP)

(73) Assignee: Hitachi High-Tech Corporation, Tokyo (JP)

(21) Appl. No.: 19/144,093

(22) PCT Filed: Nov. 30, 2023
(86) PCT No.: PCT/JP2023/042948

§ 371 Date: Jun. 27, 2025

(30) Foreign Application Priority Data
Jan. 10, 2023 (JP) 2023-001443

(51) Int. Cl. H01J 49/24; H01J 49/06

(52) U.S. Cl. CPC H01J 49/24; H01J 49/067

(57) ABSTRACT

The present disclosure is directed to avoiding damaging an optical element during maintenance of a mass spectrometer, while enabling maintenance work. A mass spectrometer is provided with: a first vacuum chamber which houses a first multipolar electrode that transports sample ions ionized at an ion source; a second vacuum chamber which is adjacent to the first vacuum chamber and houses a second multipolar electrode that transports the sample ions output from the first vacuum chamber; a latter-stage vacuum chamber which houses at least a third multipolar electrode that transports the sample ions output from the second vacuum chamber; and a detector which is provided in the succeeding stage of the latter-stage vacuum chamber so as to detect the sample ions. This mass spectrometer is configured such that the first vacuum chamber can be separated from the second vacuum chamber, which is in the succeeding stage of the first vacuum chamber.

### TECHNICAL FIELD The present disclosure relates to a mass spectrometer and a method for disassembling a mass spectrometer.

### BACKGROUND ART

A mass spectrometer that is used in an analysis of a sample ionizes a sample of an analysis object and analyzes ions corresponding to a mass-charge ratio. In general, a mass spectrometer includes: an ion source that ionizes a sample; a mass spectrometry unit that separates ions corresponding to a mass charge ratio; and a detection unit that detects a quantity of ions that passes the mass spectrometry unit.

Among constitutional elements of the mass spectrometer, the mass spectrometry unit is accommodated in a vacuum chamber. However, at the time of performing maintenance or parts exchange, there may be a case where the mass spectrometry unit is removed to the outside of the vacuum chamber.

With respect to the removal of the mass spectrometry unit performed at the time of the above-mentioned maintenance, for example, Patent Literature 1 discloses the configuration that detachably mount an ion optical element (ion lens) from a side of the device. On the other hand, Patent Literature 2 discloses the configuration where, in performing maintenance such as cleaning various types of ion optical elements arranged in an intermediate vacuum chamber, instead of removing the respective ion optical elements one after another, these elements are removed integrally as a unit from the device.

### CITATION LIST

### Patent Literature

Patent Literature 1: Japanese Unexamined Patent Application Publication No. 2021-082496

Patent Literature 2: International Publication WO 2021/106277

### Summary of Invention

### Technical Problem

However, in the technique disclosed in Patent Literature 1, at the time of removing a second multipole electrode (an optical element in a second vacuum chamber: Q0) provided subsequent to a first multipole electrode (an optical element in a first vacuum chamber: Q00), it is difficult to secure a sufficient working space on a side surface side of the second vacuum chamber. On the side surface side of the second vacuum chamber, a plurality of other analyzing devices (for example, a preprocessing liquid chromatograph) are fixedly arranged and hence, restrictions imposed on space (restriction imposed on designing) is large. Further, in a technique disclosed in Patent Literature 2, at the time of removing a unit, there is a possibility that an optical element impinges on a wall surface of a first vacuum chamber so that the optical element is broken.

The present invention has been made in view of such circumstances, and it is an object of this disclosure to provide a technique by which a damage to an optical element can be avoided at the time of performing maintenance or a parts exchange operation of a mass spectrometer and, at the same time, allows an operator to easily perform an operation such as maintenance.

### Solution to Problem

To overcome the above-mentioned problems, this disclosure provides a mass spectrometer that includes: a first vacuum chamber accommodating a first multipole electrode to transport sample ions ionized by an ion source; a second vacuum chamber adjacent to the first vacuum chamber and accommodating a second multipole electrode to transport the sample ions output from the first vacuum chamber; a last vacuum chamber accommodating at least a third multipole electrode to transport the sample ions output from the second vacuum chamber; and
a detector provided downstream of the last vacuum chamber to detect the sample ions, in which the first vacuum chamber is configured separably from the second vacuum chamber subsequent to the first vacuum chamber.

Further features concerning the disclosure will be clarified from the content of this description and the accompanying drawings. Further, the mode of this disclosure can be achieved and realized by elements, the combinations of various elements, and the detailed description and modes of claims attached to the specification described hereinafter.

The description of this specification merely describes typical examples, and is not intended to limit the claims of this disclosure or application examples in any way.

### Advantageous Effects of Invention

According to a technique of this disclosure, damage to an optical element can be avoided at the time of performing maintenance of a mass spectrometer and at the time of performing a parts exchange operation and, at the same time, the mass spectrometer can be easily disassembled and hence, an operator can perform an operation such as a maintenance.

### BRIEF DESCRIPTION OF DRAWINGS

FIG. 1 illustrates an exemplary outside configuration of a mass spectrometer 100 according to an embodiment of the present disclosure.

FIG. 2 is a schematic illustration of a procedure to remove the respective components (first vacuum chamber 103, second vacuum chamber 104, and the like) of the mass spectrometer 100.

FIG. 3A illustrates an exemplary sectional configuration (exemplary basic configuration) along an ion beam axis of each of components (ion source 101 to last vacuum chamber 105) of the mass spectrometer 100.

FIG. 3B illustrates an exemplary sectional configuration (exemplary modification) along an ion beam axis of each of components (ion source 101 to last vacuum chamber 105) of the mass spectrometer 100.

FIG. 4A illustrates an exemplary configuration of a back (surface opposed to the first vacuum chamber 103) of the ion source-side partition 102.

FIG. 4B illustrates an exemplary configuration of a front (surface opposed to the ion source-side partition 102) of the first vacuum chamber 103.

FIG. 4C illustrates an exemplary configuration of a back (surface opposed to a front of the second vacuum chamber 104) of the first vacuum chamber 103.

FIG. 4D illustrates an exemplary configuration of a front (surface opposed to a back of the first vacuum chamber 103) of the second vacuum chamber 104.

FIG. 4E illustrates an exemplary configuration of a back (surface opposed to a front of the last vacuum chamber 105) of the second vacuum chamber 104.

FIG. 4F illustrates an exemplary configuration of the front (surface opposed to a back of the second vacuum chamber 104) of the last vacuum chamber 105.

FIG. 5 is a schematic illustration of connection between the first vacuum chamber 103 and the second vacuum chamber 104.

### DESCRIPTION OF EMBODIMENTS

In a mass spectrometer, an embodiment of this disclosure relates to a technique that allows an access to an ion source, a first vacuum chamber and a second vacuum chamber from a common working space (an ion incident side in an ion beam axis direction), and reduces a restriction on the working space by a wall surface of a vacuum chamber.

Hereinafter, one embodiment of the present disclosure will be described with reference to the accompanying drawings. In the drawings, functionally identical elements may be represented by the same numerals. The attached drawings illustrate a specific embodiment that follows the principle of this disclosure. However, the embodiment is provided for understanding of this disclosure, and is not used to limitedly construe this disclosure in any way.

Further, in this embodiment, this disclosure is described in detail sufficiently for allowing those who are skilled in the art to carry out this disclosure. However, it must be understood that other mountings and modes are also possible, and the changes of configurations and structures and replacement of various elements can be performed without departing from the scope and the spirit of the technical concept of this disclosure. Therefore, the following description should not be construed as being limited to this.

### Exemplary Outside Configuration of a Mass Spectrometer 100

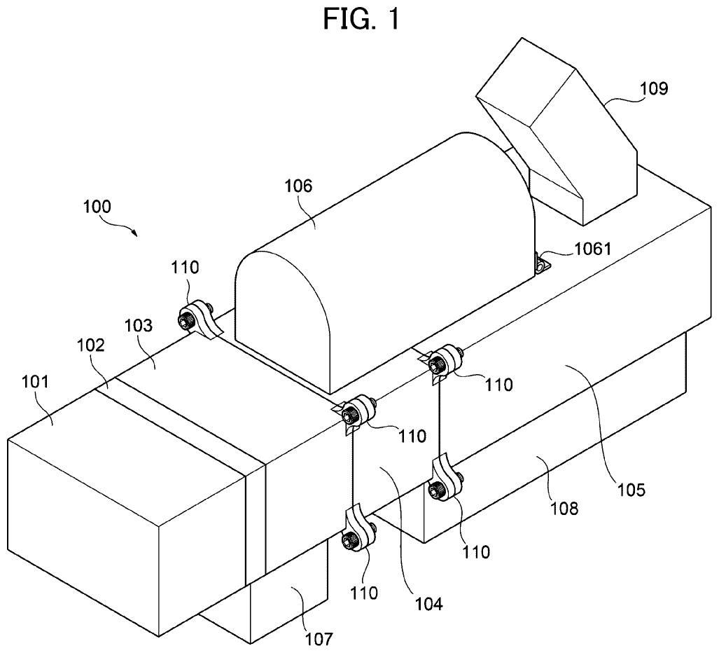

FIG. 1 illustrates an exemplary outside configuration of a mass spectrometer 100 according to an embodiment of the present disclosure. The mass spectrometer 100 includes: an ion source-side partition 102 on which an ion source 101 is mounted; a first vacuum chamber 103; a second vacuum chamber 104; a last vacuum chamber 105; a turbo molecular pump 106 that is rotatable(capable of lifting a front portion) about a rotary shaft 1061, and evacuates the second vacuum chamber 104 and the last vacuum chamber 105 into vacuum; a first support 107 that supports the first vacuum chamber 103; a second support 108 that supports the last vacuum chamber 105; and a detector 109.

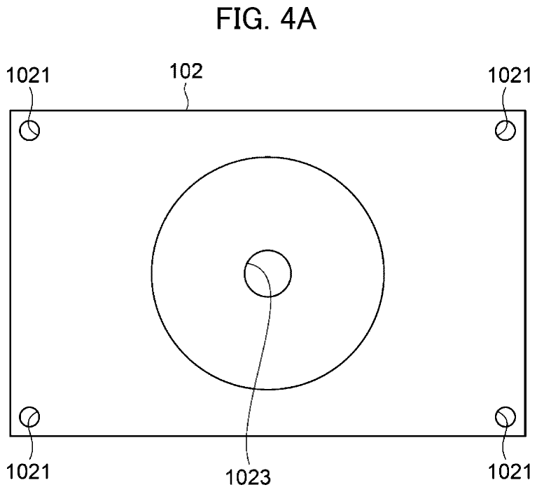

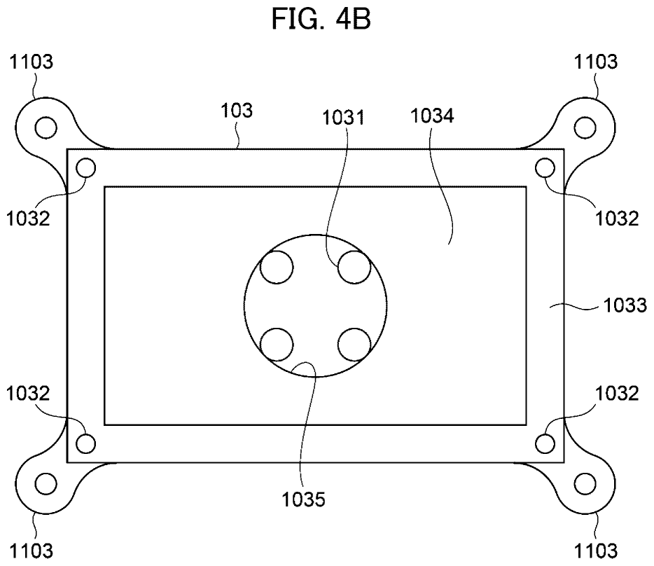

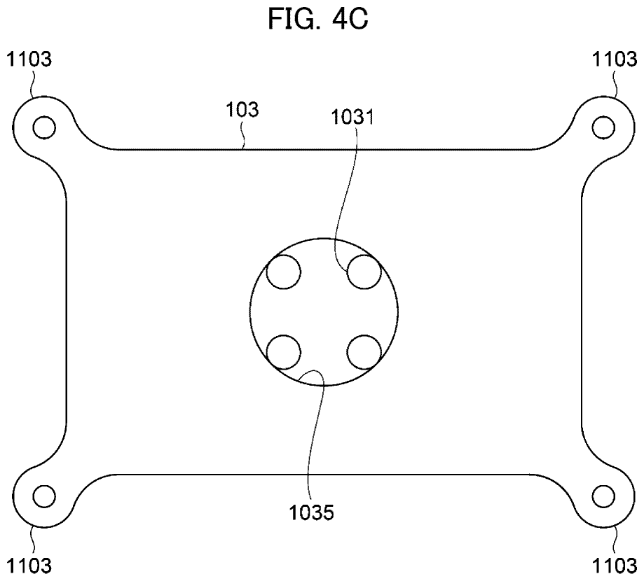

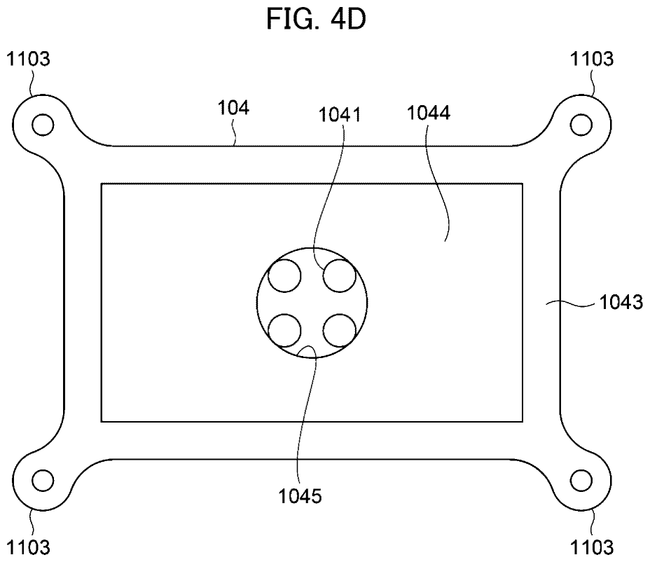

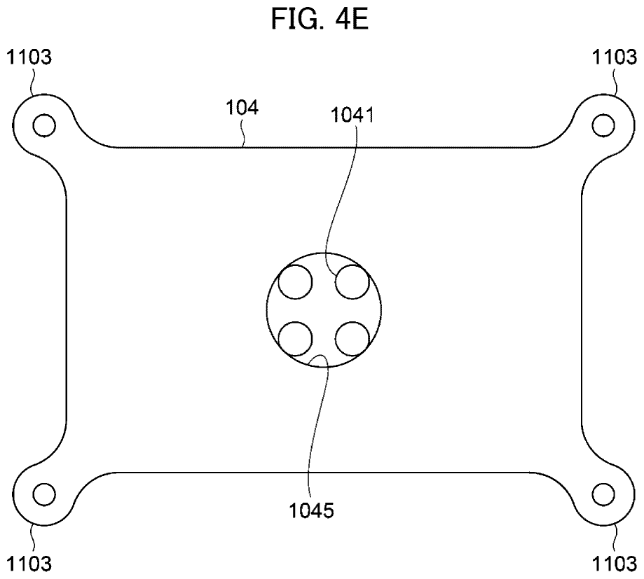

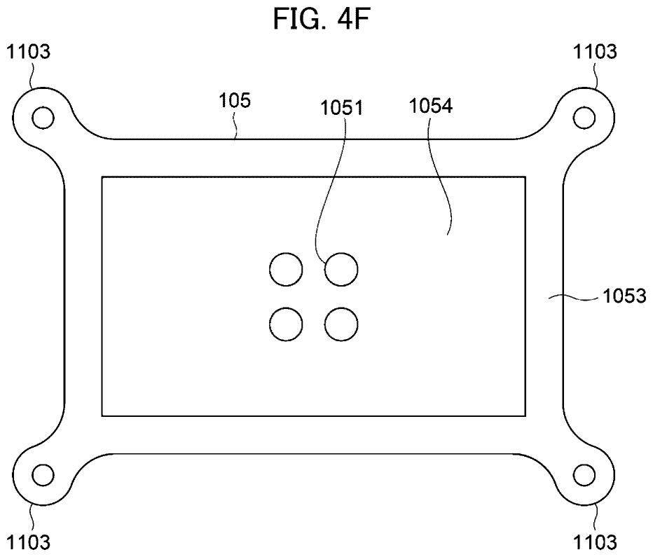

The ion source-side partition 102 has a pore (see FIG. 4A), and is detachably mounted on the first vacuum chamber 103. Detachable mounting structure between the ion source-side partition 102 and the first vacuum chamber 103 is described later.

The first vacuum chamber 103 accommodates an ion lens (a first multipole electrode Q00). An ion source 101 side, (an upstream side of the mass spectrometer 100) is detachably connected with the ion source-side partition 102. The detector 109 side (a downstream side of the mass spectrometer 100) is detachably connected with a front portion of the second vacuum chamber 104 by joints 110. The detachable structure between the first vacuum chamber 103 and the second vacuum chamber 104 is described later. The inside of the first vacuum chamber 103 is held at an atmospheric pressure of approximately several 100 pascals (for example, 200 pascals) by an outside vacuum pump (not illustrated in the drawing).

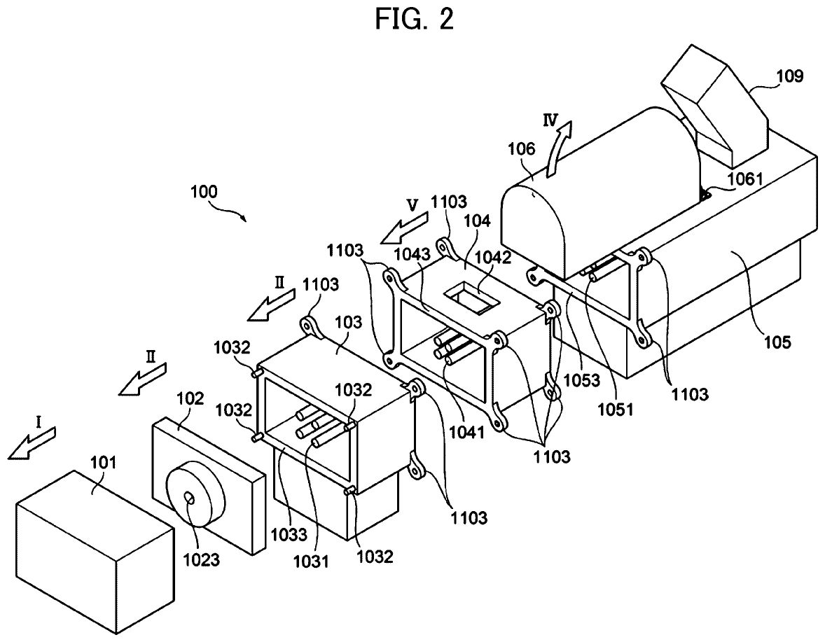

The second vacuum chamber 104 accommodates an ion lens (a second multipole electrode Q0). The ion source 101 side (an upstream side of the mass spectrometer 100) is detachably connected with a rear portion of the first vacuum chamber 103 by joints 110. A detector 109 side (a downstream side of the mass spectrometer 100) is detachably connected to a front portion (front surface) of the last vacuum chamber 105. A detachable structure between the second vacuum chamber 104 and the last vacuum chamber 105 is also described later. The turbo molecular pump 106 is detachably connected (is engaged with) with a vacuum evacuation hole 1042 (see FIG. 2) formed in an upper surface (a top surface) of the second vacuum chamber 104 (see FIG. 2). In this case, an O-ring may be mounted on a peripheral edge portion of the vacuum evacuation hole 1042 so as to enhance the degree of adhesion between the upper surface (top surface) of the second vacuum chamber 104 and an aspiration opening (not illustrated in the drawing) of the turbo molecular pump 106. The inside of the second vacuum chamber 104 is held at an atmospheric pressure of several pascals (for example, 3 pascals) by the turbo molecular pump 106.

The last vacuum chamber 105 accommodates ion lenses (multipole electrodes Q1 to Q3). An ion source 101 side (an upstream side of the mass spectrometer 100) of the ion lenses is detachably connected with a rear portion of the second vacuum chamber 104 by the joints 110.

Further, a vacuum evacuation hole (not illustrated in the drawing) formed on an upper surface of the last vacuum chamber 105 is also connected with the turbo molecular pump 106 (see FIG. 2).

The inside of the last vacuum chamber 105 is held at an atmospheric pressure of approximately 10⁻³ by the turbo molecular pump 106. In the mass spectrometer 100, it is not possible to change an atmospheric pressure (a pressure at the position of the ion source 101) to the degree of vacuum 10⁻³ level at a stroke and hence, the differential evacuation is performed so as to gradually realize the vacuum from several 100 pascals (the inside of the first vacuum chamber 103).

### Procedure to Remove Respective Components

FIG. 2 is a schematic illustration of a procedure to remove the respective components (first vacuum chamber 103, second vacuum chamber 104, and the like) of the mass spectrometer 100.
(I) For example, in a case of performing maintenance (a cleaning operation), firstly, the ion source 101 is removed from the mass spectrometer 100 in a state where the respective components are mounted (see FIG. 1).
(II) Next, the ion source-side partition 102 is removed, and a front portion of the first vacuum chamber 103 is opened. For example, the ion source-side partition 102 is mounted on the front portion of the first vacuum chamber 103 by making connecting protrusions 1032 provided to the first vacuum chamber 103 engage with protrusion receiving holes 1021 (see FIG. 4A) provided to the ion source-side partition 102 at the positions corresponding to the connecting protrusions 1032 by fitting engagement. With such a configuration, such fitting engagement is cancelled by pulling the ion source-side partition 102 toward an ion source 101 side, and the ion source-side partition 102 can be removed from the first vacuum chamber 103.

In FIG. 2, the protrusion is formed at four corner portions of the opening portion. However, the larger number of protrusions may be provided. Further, the connection between the ion source-side partition 102 and the first vacuum chamber 103 may be also realized by the joints 110 in the same manner as connection between the rear wall of the first vacuum chamber 103 and the front (opening) of the second vacuum chamber. By removing the ion source-side partition 102, an operator can get access to the ion lens (the first multipole electrode Q00) from a front side of the first vacuum chamber 103. Accordingly, the mass spectrometer 100 is in a state where an operator can easily perform cleaning of the ion lens (first multipole electrode Q00).
(III) Subsequently, the connection (the fixing) between the first vacuum chamber 103 and the second vacuum chamber 104 by the joint 110 is released, the first vacuum chamber 103 is removed from the second vacuum chamber 104, and the front portion (the front surface) of the second vacuum chamber 104 is opened. With such an operation, the first vacuum chamber 103 can be completely separated from the mass spectrometer 100. Accordingly, the first vacuum chamber 103 is moved to a maintenance place (cleaning place) that differs from a place where the mass spectrometer 100 is mounted, and it is possible to perform the maintenance (cleaning using a detergent (an organic solvent), parts exchange and the like) of the first vacuum chamber 103 and the ion lens 1031.

By separating the first vacuum chamber 103 from the mass spectrometer 100, an operator can get access to the ion lens (the second multipole electrode Q0) from a front side of the second vacuum chamber 104: Accordingly, the mass spectrometer 100 is a state where it is possible to easily perform cleaning of the ion lens (second multipole electrode Q0).
(IV) Further, by inclining the turbo molecular pump 106 in such a manner that the turbo molecular pump 106 is upwardly rotated about a rotary shaft 1061 (by lifting an ion-source side end portion of the turbo molecular pump 106), the engagement between the turbo molecular pump 106 and the vacuum evacuation hole 1042 of the second vacuum chamber 104, and the engagement between the turbo molecular pump 106 and the vacuum evacuation hole (not illustrated in the drawing) of the last vacuum chamber 105 are cancelled.
(V) Then, the connection (fixing) between the second vacuum chamber 104 and the last vacuum chamber 105 by the joint 110 is released, the second vacuum chamber 104 is removed from the last vacuum chamber 105, and the front of the last vacuum chamber 105 is opened.

Due to such an operation, the second vacuum chamber 104 can be completely separated from the mass spectrometer 100. Accordingly, the second vacuum chamber 104 is moved to a maintenance place (cleaning place) that differs from a place where the mass spectrometer 100 is mounted, and it is possible to perform the maintenance (cleaning using a detergent (an organic solvent), parts exchange and the like) of the second vacuum chamber 104. Further, an operator can get access to the ion lenses (the multipole electrodes Q1 to Q3) from a front (opening portion) of the last vacuum chamber 105, and removes the ion lenses from a casing of the last vacuum chamber 105 to the outside. Accordingly, the ion lenses (the multipole electrodes Q1 to Q3) are moved to a maintenance place (cleaning place) that differs from a place where the mass spectrometer 100 is mounted, and it is possible to perform the maintenance (cleaning using a detergent (an organic solvent) and parts exchange) of the ion lenses.

In the mass spectrometer 100, the closer the component is disposed to the ion source 101, the more likely the component is contaminated. Accordingly, the closer the component is disposed to the ion source 101, the more frequently it is necessary to perform maintenance (cleaning). For example, once every three months, the ion source-side partition 102 and the first vacuum chamber 103 are separated from the mass spectrometer 100 and are subjected to maintenance. Further, once a year, the second vacuum chamber 104 is separated from the mass spectrometer 100 and is subjected to maintenance. Further, once every seven years, the multipole electrodes Q1 to Q3 accommodated in the last vacuum chamber 105 are removed from the last vacuum chamber 105, and are subjected to maintenance. Accordingly, up to the first vacuum chamber 103, once every three months, the units are separated from the mass spectrometer 100, and up to the second vacuum chamber 104, once a year, the units are separated from the mass spectrometer 100.

### Exemplary Sectional Configuration of Respective Components of Mass Spectrometer 100

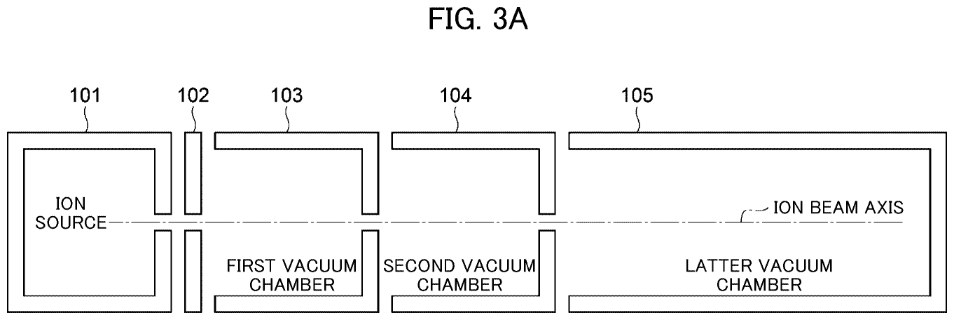

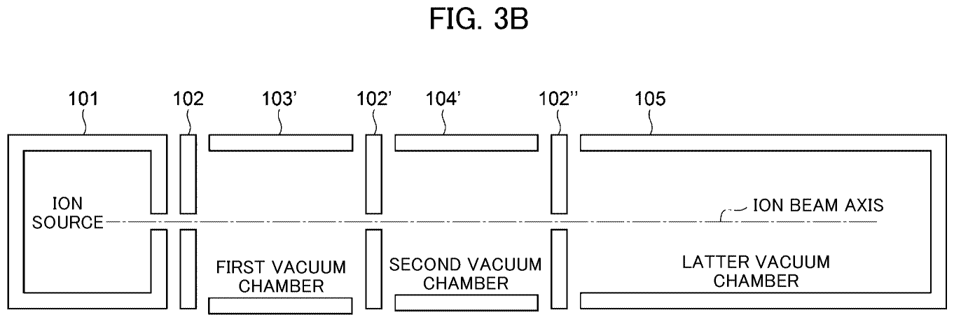

FIG. 3A and FIG. 3B illustrate exemplary cross-sectional configurations along an ion beam axis of each of components (ion source 101 to last vacuum chamber 105) of the mass spectrometer 100, respectively. FIG. 3A illustrates an exemplary sectional configuration, FIG. 3B illustrates an exemplary modification.

### (i) Exemplary Basic Configuration

As illustrated in FIG. 3A, the first vacuum chamber 103 and the second vacuum chamber 104 have the structure where the front (upstream direction: ion source side) has the open structure and the rear (downstream direction, detector side) has the structure where only an ion passing hole is formed. The first vacuum chamber 103 and the second vacuum chamber 104 each have a cross section that is an approximately horizontally U shape along an ion beam axis. The last vacuum chamber 105 has a structure where the front has an open structure and the rear has a completely closed structure. That is, the cross section of the last vacuum chamber 105 along an ion beam axis is formed in a U shape.

With respect to the first vacuum chamber 103, an ion source-side partition 102 covers the opening formed in the front of the first vacuum chamber 103. With respect to the second vacuum chamber 104, a wall surface of the first vacuum chamber 103 on a back side covers the opening formed in the front of the second vacuum chamber 104. With respect to the last vacuum chamber 105, a wall surface of the second vacuum chamber 104 on a back side covers the opening formed in the front of the last vacuum chamber 105.

In this manner, the first vacuum chamber 103 and the second vacuum chamber 104 can be separated completely independently from the mass spectrometer 100. Accordingly, it is more easily to perform an operation with respect to a component that has a shorter maintenance cycle and is disposed close to the ion source 101 side. Further, with respect to the component (for example, the first vacuum chamber 103) that is disposed on the preceding stage (upstream side), the wall surface of the back of the component covers the opening formed in the front of the component (for example, the second vacuum chamber 104) disposed on the succeeding stage (downstream side). Accordingly, the number of parts is small and hence, the separation (disassembling) operation of the respective components can be performed with ease.

### (ii) Exemplary Modification

As Illustrated in FIG. 3B, a first vacuum chamber 103′ and a second vacuum chamber 104′ may be formed in a cylindrical shape. In this case, besides an ion source-side partition 102, a partition 102′ that covers a back of a first vacuum chamber 103′ and a front of a second vacuum chamber 104′, and a partition 102″ that covers a back of a second vacuum chamber 104′ and a front of the last vacuum chamber 105. According to the exemplary modification, the number of parts is increased compared to the exemplary basic configuration (FIG. 3A) and hence, the separation (the disassembling operation) of the respective units from the mass spectrometer 100 becomes cumbersome. On the other hand, careful maintenance can be applied to the details of the respective components.

### Exemplary Back Configuration and Exemplary Front Configuration of Respective Components

FIG. 4A to FIG. 4F are views illustrating an exemplary back configuration and an exemplary front configuration of respective components (from the ion source-side partition 102 to the last vacuum chamber 105). FIG. 4A is a view illustrating an exemplary configuration of a back of the ion source-side partition 102 (a surface opposed to the first vacuum chamber 103).

FIG. 4B is a view illustrating an exemplary configuration of a front of the first vacuum chamber 103 (a surface opposed to the ion source-side partition 102). FIG. 4C is a view illustrating an exemplary configuration of a back of the first vacuum chamber 103 (a surface opposed to the front of the second vacuum chamber 104). FIG. 4D is a view illustrating an exemplary configuration of a front of the second vacuum chamber 104 (a surface opposed to the back of the first vacuum chamber 103). FIG. 4E is a view illustrating an exemplary configuration of a back of the second vacuum chamber 104 (a surface opposed to the front of the last vacuum chamber 105). FIG. 4F is a view illustrating an exemplary configuration of a front of the last vacuum chamber 105 (a surface opposed to the back of the second vacuum chamber 104).

On a back of the ion source-side partition 102, a pore 1023 through which ions emitted from the ion source 101 pass and a plurality of protrusion receiving holes 1021 with which a plurality of connecting protrusions 1032 of the first vacuum chamber 103 engage can be observed (see FIG. 4A).

As viewed from the front of the first vacuum chamber 103, the ion lens (the multipole electrode Q00) 1031 accommodated in the lens accommodating portion 1034, and a plurality of connecting protrusions 1032 mounted on the casing frame 1033 are observed (see FIG. 4B). Ions pass through a space at the center surrounded by multipole electrodes Q00 (quadruple electrodes in FIG. 4B as an example) of the ion lens 1031.

To view a rear of the first vacuum chamber 103, a plurality of mounting lugs 1103 for joints 110 that are provided to a wall surface (four corners of the wall surface in FIG. 4C), an ion lens hole 1035, and ion lenses (multipole electrodes Q00: quadruple electrodes) 1031 are observed (see FIG. 4C). The ion lenses 1031 are arranged to be brought into contact with an inner periphery of the ion lens hole 1035. Ions that pass through the space at the center surrounded by the multipole electrodes Q00 (quadruple electrodes) of the ion lenses 1031 are directly guided to spaces at the center of the ion lenses 1041 of the second vacuum chamber 104.

To view a front of the second vacuum chamber 104, the ion lenses (multipole electrodes Q0) 1041 accommodated in the lens accommodating portion 1044, and a plurality of mounting lugs 1103 for joints 110 that are provided to a wall surface (four corners of the wall surface in FIG. 4D) are observed (see FIG. 4D). Ions pass through the space at the center surrounded by the multipole electrodes Q0 (quadruple electrodes) of the ion lens 1041.

To view a back of the second vacuum chamber 104, a plurality of mounting lugs 1103 for joints 110 that are provided to a wall surface (four corners of the wall surface in FIG. 4E), an ion lens hole 1045, and ion lenses (multipole electrodes Q00: quadruple electrodes) 1041 are observed (see FIG. 4E). The ion lenses 1041 are arranged to be brought into contact with an inner periphery of the ion lens hole 1045. Ions that pass through the space at the center surrounded by the multipole electrodes Q0 (quadruple electrodes) of the ion lens 1031 are directly guided to spaces at the center of the ion lenses 1051 of the last vacuum chamber 105.

To view a front of the last vacuum chamber 105, the ion lenses (multipole electrodes Q1to Q3) 1051 accommodated in the lens accommodating portion 1054, and a plurality of mounting lugs 1103 for joints 110 that are provided to a wall surface (four corners of the wall surface in FIG. 4F) are observed (see FIG. 4F). Ions pass through the space at the center surrounded by the multipole electrodes Q0 (quadruple electrodes) of the ion lens 1051, and are guided to the detector 109.

With respect to a diameter φ1 of the pore 1023 of the ion source-side partition 102, a diameter φ2 of the ion lens hole 1035 on the back of the first vacuum chamber 103, and a diameter φ3 of the ion lens hole 1045 on the back of the second vacuum chamber 104, the relationship between the sizes of these diameters can be set to φ1<φ3<φ2.

### Connection Between Respective Components

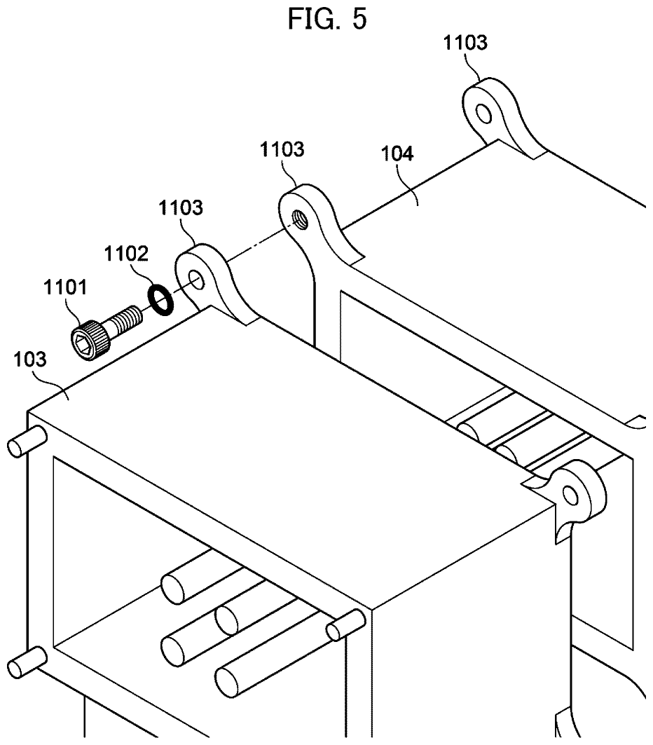

FIG. 5 is a schematic illustration of connection between the first vacuum chamber 103 and the second vacuum chamber 104. The connection between the second vacuum chamber 104 and the last vacuum chamber 105 is substantially equal to the method illustrated in FIG. 5 and hence, the description of the connection is omitted.

When the back of the first vacuum chamber 103 and the front (opening) of the second vacuum chamber 104 are joined to each other without forming a gap therebetween, the mounting lugs 1103 of the joints 110, which are formed at four corner portions respectively, are accurately aligned with each other. A bolt hole is formed in each of the respective mounting lugs 1103.

In a state where the mounting lugs 1103 of the first vacuum chamber 103 and the mounting lugs 1103 of the second vacuum chamber 104 are made to butt against each other, for example, the mounting lugs 1103 of the first vacuum chamber 103 and the mounting lugs 1103 of the second vacuum chamber 104 are fixed to each other by the bolts 1101 via O-rings 1102 from the mounting lug 1103 side of the first vacuum chamber 103. The mounting lugs 1103 of the first vacuum chamber 103 and the mounting lugs 1103 of the second vacuum chamber 104 are fastened to each other by the bolts via the O-rings 1102 and hence, a torque for fixing both the mounting lugs 1103 of the first vacuum chamber 103 and the mounting lugs 1103 of the second vacuum chamber 104 can be increased. For example, by forming a recessed portion (a circumferential portion) on a front casing frame 1043 of the second vacuum chamber 104 and by mounting an O-ring in the recessed portion, the rear of the first vacuum chamber 103 and the front of the second vacuum chamber 104 may be fixed to each other without forming a gap therebetween.

### Recapitulation

(i) The mass spectrometer 100 according to this embodiment includes: the first vacuum chamber 103 accommodating the first multipole electrodes 1031 to transport sample ions ionized by the ion source 101; the second vacuum chamber 104 adjacent to the first vacuum chamber 103 and accommodating the second multipole electrodes 1041 to transport the sample ions output from the first vacuum chamber 103; the last vacuum chamber 105 accommodating at least the third multipole electrodes 1051 to transport the sample ions output from the second vacuum chamber 104; and the detector 109 provided downstream of the flow of the sample ions with respect to the last vacuum chamber to detect the sample ions. In such a configuration, the first vacuum chamber 103 is configured separably from the second vacuum chamber 104 subsequent to the first vacuum chamber 103. In this manner, by adopting the configuration where the first vacuum chamber 103 can be individually separated from the mass spectrometer 100, it is possible to efficiently perform a maintenance operation of the electrodes 1031 that are accommodated in the first vacuum chamber 103, and are closest to the ion source 101 thus being easily smeared and having a shorter maintenance cycle than other electrodes 1041 and 1051.

In this embodiment, the first vacuum chamber 103 and the second vacuum chamber 104 are partitioned by the common wall surface (ion lens holes being formed therein). As the mode of the common wall surface, a mode where the front (the front opening) of the second vacuum chamber is covered by the wall surface of the back of the first vacuum chamber 103 (mode I: see FIG. 3A); a mode where the first vacuum chamber 103 and the second vacuum chamber 104 are formed of a cylindrical casing respectively and openings formed in both the first vacuum chamber 103 and the second vacuum chamber 104 are covered by independent wall surfaces (the ion lens holes being formed in the wall surfaces)(mode II: see FIG. 3B) can be adopted. In the mode I, the number of parts can be reduced. Accordingly, the mode I has an advantageous effect that an operation efficiency is enhanced. In the mode II, although the number of parts is increased, the mode II has an advantageous effect that the respective parts can be finely cleaned.

Also with respect to the relationship between the second vacuum chamber 104 and the last vacuum chamber 105, the mode I and the mode II can be adopted. However, with respect to the last vacuum chamber 105, only the front being proximal to the ion source 101 is opened, and the rear being distal from the ion source 101 is sealed (no opening).

With respect to the separation structure of the each vacuum chamber (see FIG. 5), the first vacuum chamber 103 has the first joints (mounting lugs) 1103 on the wall surface of the back thereof for connecting the first vacuum chamber 103 with the second vacuum chamber 104, and the second vacuum chamber 104 has the second joints (mounting lugs) 1103 on the front thereof for connecting the second vacuum chamber 104 with the first vacuum chamber 103.

The first joint (mounting lug) 1103 and the second joint (mounting lug) 1103 each have the bolt hole, and the first joint (mounting lug) 1103 and the second joint (mounting lug) 1103 are fixedly secured to each other by the bolt 1101 inserted into the bolt holes. With such an operation, the first vacuum chamber 103 and the second vacuum chamber 104 are joined to each other. The bolt 1101 may be inserted into the bolt holes formed in the joints (mounting lugs) 1103 by way of the O-ring 1102. With the use of the O-ring, a fastening torque generated by the bolt 1101 can be increased.
(ii) This embodiment also suggests a method of disassembling the mass spectrometer 100. As described above, the mass spectrometer 100 includes: the first vacuum chamber 103 that is separably connected with ion source 101 via the ion source-side partition 102; the second vacuum chamber 104 with which the first vacuum chamber 103 is separably connected; the last vacuum chamber 105 with which the second vacuum chamber 104 is separably connected; and the turbo molecular pump 106 that controls a degree of vacuum in the second vacuum chamber 104 and a degree of vacuum in the last vacuum chamber 105. The method of disassembling the mass spectrometer 100 includes: removing the ion source 101 from the ion source-side partition 102; removing the ion source-side partition 102 from the first vacuum chamber 103, and separating the first vacuum chamber 103 from the second vacuum chamber 104 by releasing the connection at the joint 110 between the first vacuum chamber 103 and the second vacuum chamber 104. In this manner, the first vacuum chamber 103 that is disposed at a preceding stage (proximal to the ion source 101) can be individually separated (that is, it is unnecessary to release the engagement of the turbo molecular pump 106) and hence, even in a case where the maintenance is frequently applied to the multipole electrodes 1031 that are accommodated in the first vacuum chamber 103 that is liable to be easily smeared, it is possible to efficiently perform a maintenance operation. The first vacuum chamber 103 and the second vacuum chamber 104 are connected with each other by fastening respective joints (mounting lugs) 1103 to each other by the bolts. Accordingly, the first vacuum chamber 103 can be easily separated from the second vacuum chamber 104.

Further, the method of disassembling the mass spectrometer 100 includes: releasing the engagement between the turbo molecular pump 106 and the second vacuum chamber 104 and the last vacuum pump 105; and separating the second vacuum chamber 104 from the last vacuum chamber 105 by releasing the connection at the joints (mounting lugs) 1103 between the second vacuum chamber 104 and the last vacuum chamber 105. The turbo molecular pump 106 is disposed on a top surface of the last vacuum chamber 105 in a state where the turbo molecular pump 106 rotates about a rotary shaft 1061 of a rear end portion. Further, the second vacuum chamber 104 and the last vacuum chamber 105 each have an opening portion (an opening portion (vacuum evacuation hole) 1042 formed in the second vacuum chamber 104 and an opening portion formed in the last vacuum chamber 105 (not illustrated in the drawing) on the top surfaces thereof. The turbo molecular pump 106 engages with the second vacuum chamber and the last vacuum chamber in such a manner that the turbo molecular pump 106 covers the respective openings. Further, the second vacuum chamber 104 and the last vacuum chamber 105 are, in the same manner as the first vacuum chamber 103 and the second vacuum chamber 104, are joined to each other by fastening the respective joints (mounting lugs) 1103 by bolts. In this case, the releasing of the engagement of the turbo molecular pump 106 includes exposing the opening (vacuum evacuation hole) 1042 of the second vacuum chamber 104 and the opening (not illustrated in the drawing) of the last vacuum chamber by axially rotating the turbo molecular pump 106 by the rotary shaft 1061 of the rear end portion. Further, the separation of the second vacuum chamber 104 from the last vacuum chamber 105 includes releasing of fastening by the bolts. In accordance with processing described above, the mass spectrometer 100 can be disassembled to the respective components only with an extremely simple operation. Further, the mass spectrometer 100 can be disassembled with man-hours corresponding to the maintenance level.
(iii) In this disclosure, the specific embodiment is described. However, in all aspects, these are not provided for limiting the scope of the present invention, and are provided for the description of the present invention (for facilitating the understanding of the techniques of the present invention). Further, it must be noted that those who are skilled in the art can clearly understand this disclosure and its mounting method by considering the present embodiment. The specification and examples are merely typical expressions, and the technical scope and spirit of this disclosure is expressed in succeeding claims.

### LIST OF REFERENCE SIGNS

100 Mass spectrometer
101 Ion source
102 Ion source-side partition
103 First vacuum chamber
104 Second vacuum chamber
105 Last vacuum chamber
106 Turbo molecular pump
107 First support
108 Second support
109 Detector
110 Joint

1. A mass spectrometer, comprising:
a first vacuum chamber accommodating a first multipole electrode to transport sample ions ionized by an ion source;
a second vacuum chamber adjacent to the first vacuum chamber and accommodating a second multipole electrode to transport the sample ions output from the first vacuum chamber;
a last vacuum chamber accommodating at least a third multipole electrode to transport the sample ions output from the second vacuum chamber; and
a detector provided downstream of the flow of the sample ions with respect to the last vacuum chamber to detect the sample ions, wherein
the first vacuum chamber is configured separably from the second vacuum chamber subsequent to the first vacuum chamber.

2. The mass spectrometer according to claim 1, wherein when the first vacuum chamber and the second vacuum chamber are connected together to configure the mass spectrometer, the first vacuum chamber is separated from the second vacuum chamber by a common wall surface.

3. The mass spectrometer according to claim 2, wherein the first vacuum chamber and the second vacuum chamber each have a front being proximal to the ion source and wholly opened, and have a back being distal to the ion source and having an ion lens hole to provide the first multipole electrode or the second multipole electrode, and
in a state where the first vacuum chamber and the second vacuum chamber are connected together, a wall surface of the back of the first vacuum chamber is configured to cover the opening of the front of the second vacuum chamber.

4. The mass spectrometer according to claim 3, wherein the last vacuum chamber has a front being proximal to the ion source and wholly opened, and
in a state where the second vacuum chamber and the last vacuum chamber are connected together, a wall surface of the back of the second vacuum chamber is configured to cover the opening of the front of the last vacuum chamber.

5. The mass spectrometer according to claim 2, wherein
the first vacuum chamber and the second vacuum chamber each is formed of a cylindrical casing,
the mass spectrometer further comprises a first common wall, the first common wall covering the opening of the back of the first vacuum chamber, covering the opening of the front of the second vacuum chamber, and having an ion lens hole to provide the first multipole electrode, the back being distal to the ion source, the front being proximal to the ion source, the first common wall separating the first vacuum chamber from the second vacuum chamber.

6. The mass spectrometer according to claim 5, further comprising a second common wall that covers the opening of the back of the second vacuum chamber, covers the opening of the front of the last vacuum chamber, and has an ion lens hole to provide the second multipole electrode, the back being distal to the ion source, the front being proximal to the ion source, the second common wall separating the second vacuum chamber from the last vacuum chamber.

7. The mass spectrometer according to claim 1, further comprising an ion source-side partition disposed between the ion source and the first vacuum chamber and having a pore through which the sample ions pass, wherein
the ion source-side partition has a front proximal to the ion source and a back distal to the ion source, and the ion source is attached to the front while the first vacuum chamber is attached to the back.

8. The mass spectrometer according to claim 3, wherein the first vacuum chamber has a first joint on the wall surface of the back of the first vacuum chamber for connection with the second vacuum chamber,
the second vacuum chamber has a second joint on the front of the second vacuum chamber for connection with the first vacuum chamber,
the first joint and the second joint each have a bolt hole, and
the first joint and the second joint are bound together with bolts inserted into the bolt holes, thereby the first vacuum chamber and the second vacuum chamber are connected together.

9. The mass spectrometer according to claim 8, wherein the bolts are each inserted into the bolt hole via an O-ring.

10. A method for disassembling a mass spectrometer, the mass spectrometer including a first vacuum chamber separably connected to an ion source via a partition, a second vacuum chamber separably connected to the first vacuum chamber, a last vacuum chamber separably connected to the second vacuum chamber, and a turbo molecular pump to control the degree of vacuum in the second vacuum chamber and the degree of vacuum in the last vacuum chamber,
the method comprising:
removing the ion source from the partition;
removing the partition from the first vacuum chamber; and
releasing connection at a joint between the first vacuum chamber and the second vacuum chamber, and thus separating the first vacuum chamber from the second vacuum chamber.

11. The method according to claim 10, further comprising:
releasing engagement of the turbo molecular pump with the second vacuum chamber and with the last vacuum chamber; and
releasing connection at a joint between the second vacuum chamber and the last vacuum chamber and thus separating the second vacuum chamber from the last vacuum chamber.

12. The method according to claim 10, wherein the joint between the first vacuum chamber and the second vacuum chamber is formed by joining using a bolt inserted into a bolt hole provided in the first vacuum chamber and a bolt hole provided in the second vacuum chamber, and separating the first vacuum chamber from the second vacuum chamber includes releasing the joining.

13. The method according to claim 11, wherein
the turbo molecular pump is provided on a top surface of the last vacuum chamber to allow axial rotation of a rear end portion of the turbo molecular pump,
the second vacuum chamber and the last vacuum chamber each have a top surface having an opening while the turbo molecular pump is engaged with the second vacuum chamber and with the last vacuum chamber so as to cover the openings,
the joint between the second vacuum chamber and the last vacuum chamber is formed by joining with a bolt inserted into a bolt hole provided in the second vacuum chamber and a bolt hole provided in the last vacuum chamber,
releasing the engagement of the turbo molecular pump includes exposing the opening of the second vacuum chamber and the opening of the last vacuum chamber by axially rotating the turbo molecular pump, and
separating the second vacuum chamber from the last vacuum chamber includes releasing the joining.
